(19) United States
(12) Patent Application Publication
(10) Pub. No.: US 2008/0219754 A1
(43) Pub. Date: Sep. 11, 2008

(54) FIXING METHOD AND FIXING DEVICE

(75) Inventor: Wei-Tang Lee, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AMA PRECISION INC., Taipei (TW)

(21) Appl. No.: 12/045,015

(22) Filed: Mar. 9, 2008

(30) Foreign Application Priority Data
Mar. 9, 2007 (TW) 96108250

(51) Int. Cl. B62D 7/22; B23P 11/00

(52) U.S. Cl. 403/42; 29/525.01

(57) ABSTRACT

A fixing device including a fixer and a fixing structure is provided, wherein the fixing structure has a holding space and a limiting portion. The limiting portion is located at the inner wall of one side of the holding space. In addition, the fixer is limited in the holding space by the limiting portion. Furthermore, a fixing method for fastening the fixer in the holding space is also provided.

### CROSS-REFERENCE TO RELATED APPLICATION

This application claims the priority benefit of Taiwan application serial no. 96108250, filed on Mar. 9, 2007. The entirety of the above-mentioned patent application is hereby incorporated by reference herein and made a part of this specification.

### BACKGROUND OF THE INVENTION

1. Field of the Invention

The invention relates to a fixing device and a fixing method and, more particularly, to a fixing device and a fixing method for fastening a fixer.

2. Description of the Related Art

In recent years, with the rapid development of the science and technology, the operation speed of electronic devices in a computer is continuously increased, so that -the heat generation power of the electronic devices is also increased. To prevent the electronic devices in the computer from being overheated and losing effectiveness temporarily or permanently, the electronic devices need enough heat dissipation ability to make them work normally.

FIG. 1A is a combined diagram showing a conventional heat sink, and FIG. 1B is an exploded diagram showing what is shown in FIG. 1A. Please refer to FIG. 1A and FIG. 1B. The heat sink 100 includes a plate body 110, a fin assembly 120, a plurality of spring screws 130 and a plurality of E-rings 140. The fin assembly 120 is provided at the plate body 110, and the spring screw 130 is composed of a screw 132 and a spring 134. In addition, the plate body 110 has a plurality of locking holes 112, and the spring screws 130 are provided through the locking holes 112. To make the spring screws 130 fixed at the locking holes 112, in the conventional technology, the E-ring 140 is fastened in a groove 132a of the screw 132. In this way, the spring screw 130 can be fixed in the locking hole 112.

However, since the E-ring 140 is additionally used to fix the spring screw 130 at the locking hole 112 of the plate body 110 in the conventional technology, the conventional heat sink has a high material cost. On the other hand, since the E-ring 140 which is assembled at the heat sink 100 is fastened at the groove 132a of the screw 132 in a manual manner, the conventional heat sink 100 has a higher assembly cost.

### BRIEF SUMMARY OF THE INVENTION

One objective of the invention is to provide a fixing device with a lower manufacture cost.

Another objective of the invention is to provide a fixing method for manufacturing the fixing device.

To obtain the above or other objectives, the invention provides a fixing device including a fixer and a fixing structure. The fixing structure has a holding space and a limiting portion provided at the inner wall of the holding space, wherein the limiting portion is used for limiting the fixer in the holding space.

In one embodiment of the invention, the holding space has an opening at a side of holding space where the limiting portion is provided, and the diameter of the opening is less than the outer diameter of the top of the fixer.

In one embodiment of the invention, the outer edge of the top of the fixer has a fastening structure, and the limiting portion interferes with the fastening structure.

In one embodiment of the invention, the holding space has an opening at a side of the holding space where the limiting portion is provided, and the diameter of the opening is less than the outer diameter of the fastening structure.

In one embodiment of the invention, the fixer is a spring screw.

The invention provides a fixing method which comprises the following steps. First, a fixer structure having a holding space and a protrusion is provided, and the protrusion is around the holding space. Then, a fixer is placed into the holding space. Afterward, the protrusion is made deformed to form a limiting portion which limits the fixer in the holding space.

In one embodiment of the invention, before the fixer is limited in the holding space, the diameter of the opening at a side of the holding space where the protrusion is provided is larger than the diameter of the opening at the other side.

In one embodiment, after the fixer is limited in the holding space, the hold diameter of the opening at a side of the holding space where the limiting portion is provided is less than the outer diameter of the fixer.

In the fixing method of the invention, a protrusion is provided around the holding space of the fixing structure. After the fixer is placed into the holding space, since the protrusion has a characteristic of extension, in the invention, the protrusion can be made deformed toward the fixer to form a limiting portion. In this way, the limiting portion can make the fixer limited in the holding space. Compared with the conventional technology, in the invention, a fastening element such as an E-ring does not need to be used additionally to fasten the fixer, and therefore, the fixing structure in the invention has a lower material cost and an assembly cost.

These and other features, aspects, and advantages of the present invention will become better understood with regard to the following description, appended claims, and accompanying drawings.

### BRIEF DESCRIPTION OF THE DRAWINGS

FIG. 1A is a combined diagram showing a conventional heat sink.

FIG. 1B is an exploded diagram showing what is shown in FIG. 1A.

FIG. 2 is a flowchart showing a fixing method of a preferred embodiment of the invention.

FIG. 3 is a schematic diagram showing a heat sink.

FIG. 4A to FIG. 4D are flowchart schematic diagrams showing a fixing method of a preferred embodiment of the invention.

FIG. 5A is a section diagram showing what is shown in FIG. 4A along the I-I′ line.

FIG. 5B is a section diagram showing what is shown in FIG. 4C along the II-II′ line.

FIG. 5C is a section diagram showing what is shown in FIG. 4D along the III-III′ line.

FIG. 6A to FIG. 6D are flowchart schematic diagrams showing another fixing method of a preferred embodiment of the invention.

FIG. 7 is a section diagram showing what is shown in FIG. 6D along the IV-IV′ line.

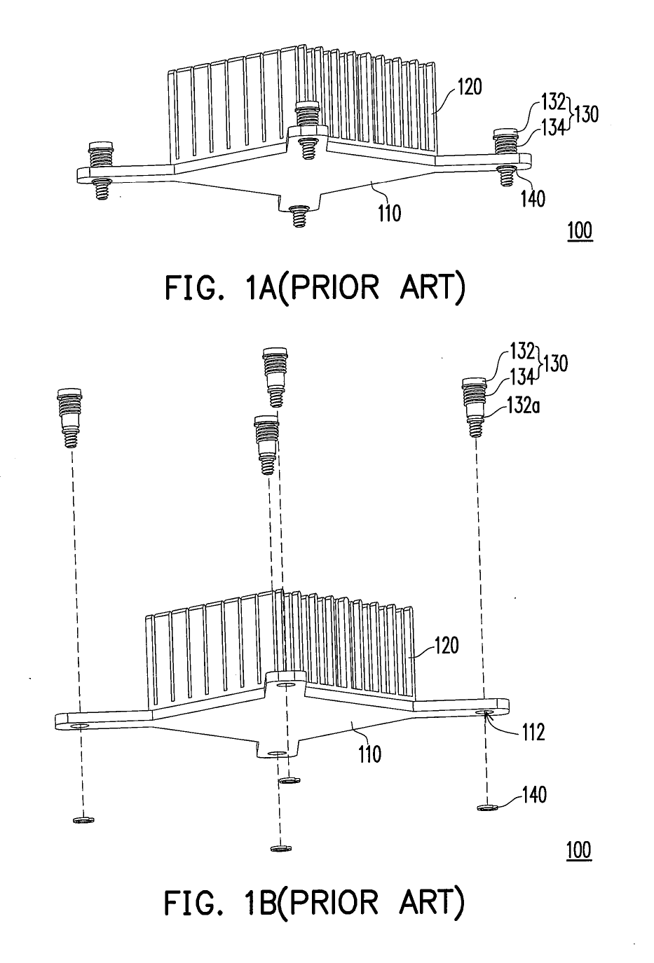

### DETAILED DESCRIPTION OF THE EMBODIMENTS

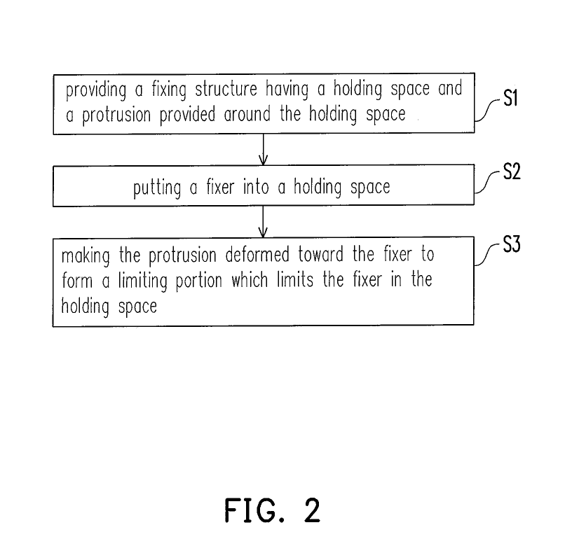

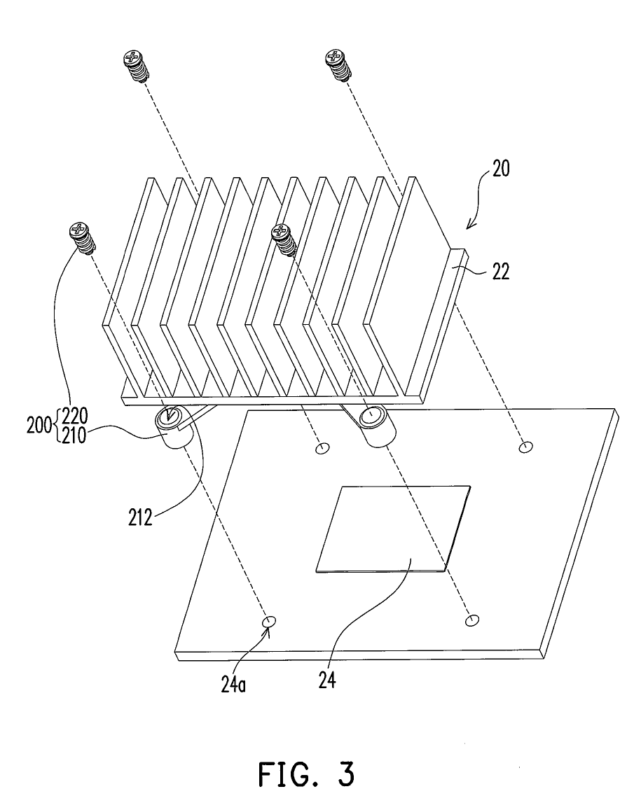

FIG. 2 is a flowchart showing a fixing method of a preferred embodiment of the invention. Please refer to FIG. 2. The fixing method of the embodiment includes the following steps. First, the step S1 is done. A fixing structure having a holding space and a protrusion is provided, and the protrusion is around the holding space. Then, step S2 is done. A fixer is placed into the holding space. Afterwards, the step S3 is done. The protrusion is made deformed toward the fixer to form a limiting portion, wherein the limiting portion limits the fixer in the holding space. In the embodiment, the fixing structure 210 is, for example, a structure extending from the plate body 22 of the heat sink 20 (Please refer to FIG. 3, which is a schematic diagram showing a heat sink), and the fixer 220 is fastened in the holding space 212 of the fixing structure 210. In this way, when users want to fix the heat sink 20 at a heat source 24, they can fasten the fixer 220 such as a screw or a spring screw at the fixing hole 24a around the heat source directly. The fixing method is described with the detailed flowchart schematic diagram in the embodiment hereinbelow.

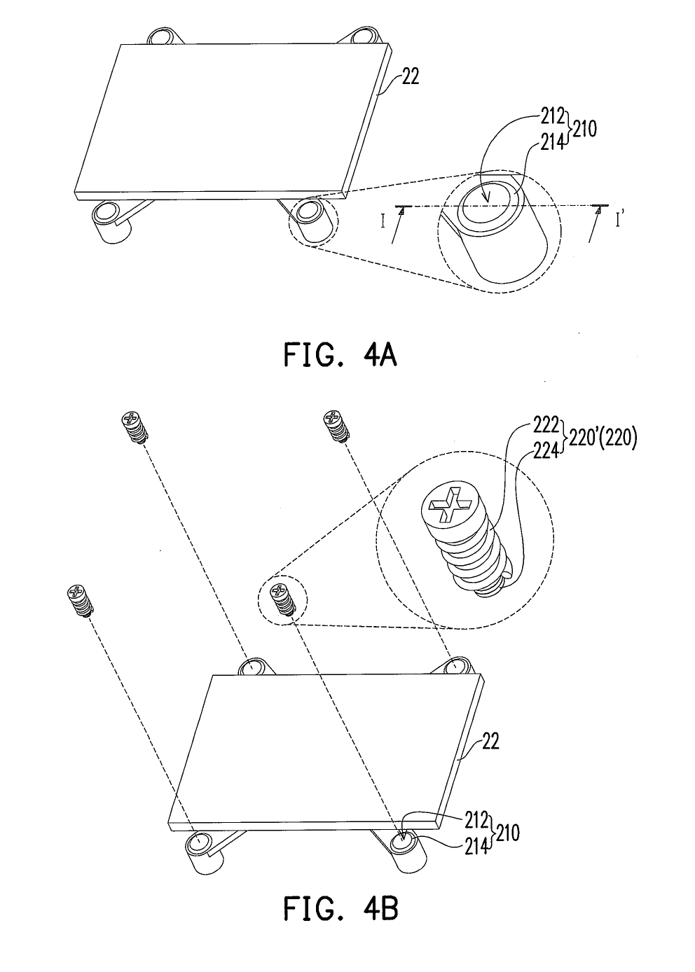

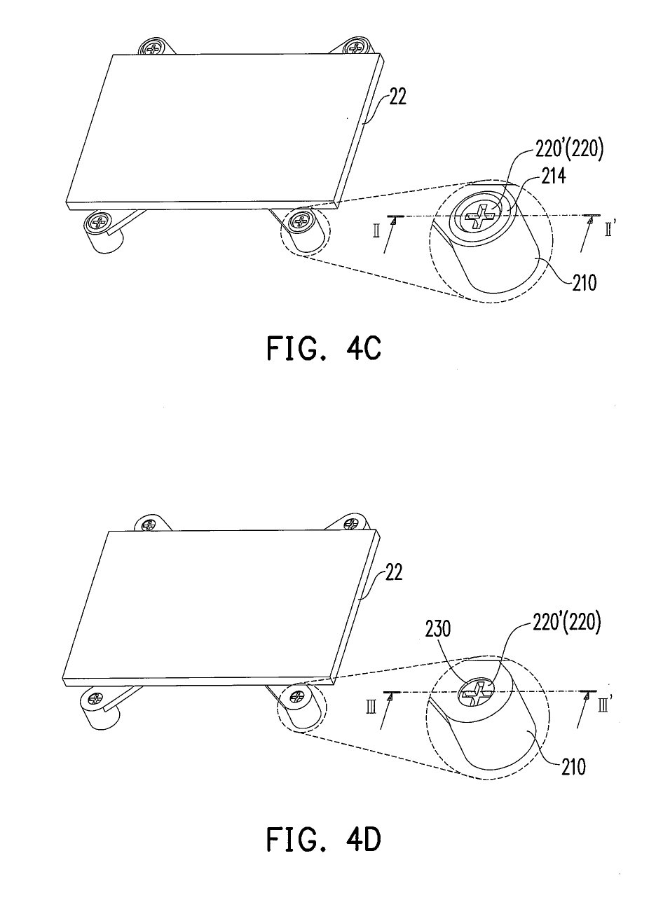

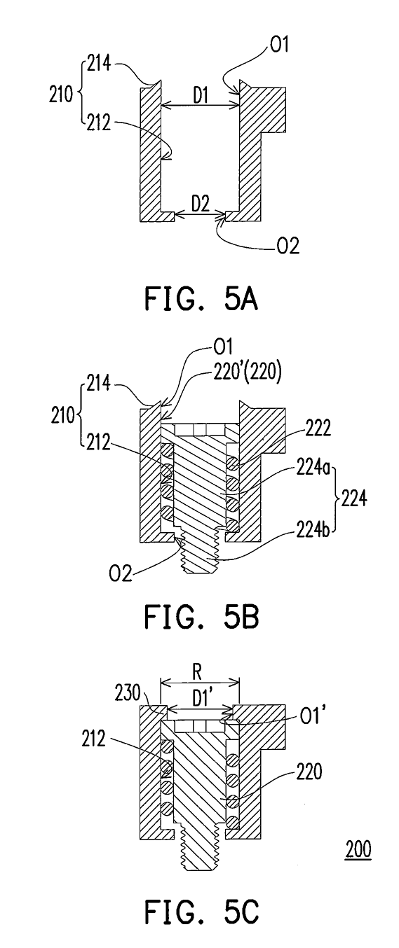

FIG. 4A to FIG. 4D are flowchart schematic diagrams showing a fixing method of a preferred embodiment of the invention. The fixing method of the embodiment is stated hereinbelow. First, as shown in FIG. 4A, a fixing structure 210 is provided, wherein the fixing structure 210 extends from, for example, the plate body 22 of the heat sink 20 (please refer to FIG. 3). In the embodiment, the fixing structure 210 has a holding space 212 and a protrusion 214. To make the relative position between the holding space 212 and the protrusion 214 clear, please refer to FIG. 5, which is a section diagram showing what is shown in FIG. 4A along the line I-I′. In FIG. 5A, the protrusion 214 is around the holding space 212, and the two sides of the holding space 212 has a first opening O1 and a second opening O2, respectively, wherein the diameter D2 of the second opening O2 is less than the diameter D1 of the first opening O1.

As shown in FIG. 4B to FIG. 4C, the fixer 220 such as a spring screw 220′ is placed into the holding space 212 (the spring screw 220′ includes a spring 222 and a screw 224). Similarly, to make the relative position between the spring screw 220′ and the holding space 212 after the spring screw 220′ is put into the holding space 212 clear, please refer to FIG. 5B again. FIG. 5B is a section diagram showing what is shown in FIG. 4C along line II-II′. As shown in FIG. 5B, after the spring screw 220′ is put into the holding space 212, the rod body 224a of the screw 224 can be fixed in the holding room 212 via the spring 222, while the locking portion 224b (such as the thread) of the screw 224 is provided through the second opening O2 of the holding space 212.

Afterwards, as shown in FIG. 4D, the protrusion 214 (please refer to FIG. 4C) is made deformed toward the fixer 220 to form a limiting portion 230, wherein the people in the art can make the protrusion 214 punched by a proper tool machine to make the protrusion 214 deformed. Please refer to FIG. 4D and FIG. 5C simultaneously. FIG. 5C is a section diagram showing what is shown in FIG. 4D along the line III-III′. As shown in FIG. 4D and FIG. 5C, after the protrusion 214 is deformed toward the fixer 220, the protrusion 214 forms a limiting portion 230 for limiting the fixer 220. Specifically, after the protrusion 214 is deformed toward the fixer 220 to form the limiting portion 230, the diameter D1′ of the opening O1′ at a side of the holding space 212 where the limiting portion is provided is less than the outer diameter R of the top of the fixer 220, and the limiting portion 230 can limit the fixer 220 in the holding space 212 effectively. In this way, users do not need to worry about that the fixer 220 separates from the heat sink 20 (please refer to FIG. 3) to cause the inconvenience in the assembly later.

Since the fixer 220 is directly limited in the holding space 212 of the fixing structure in the embodiment, in the process of assembling the heat sink 20 which is provided with the fixing device 200, any fastening element does not need to be additionally used to fasten the fixer. 220.

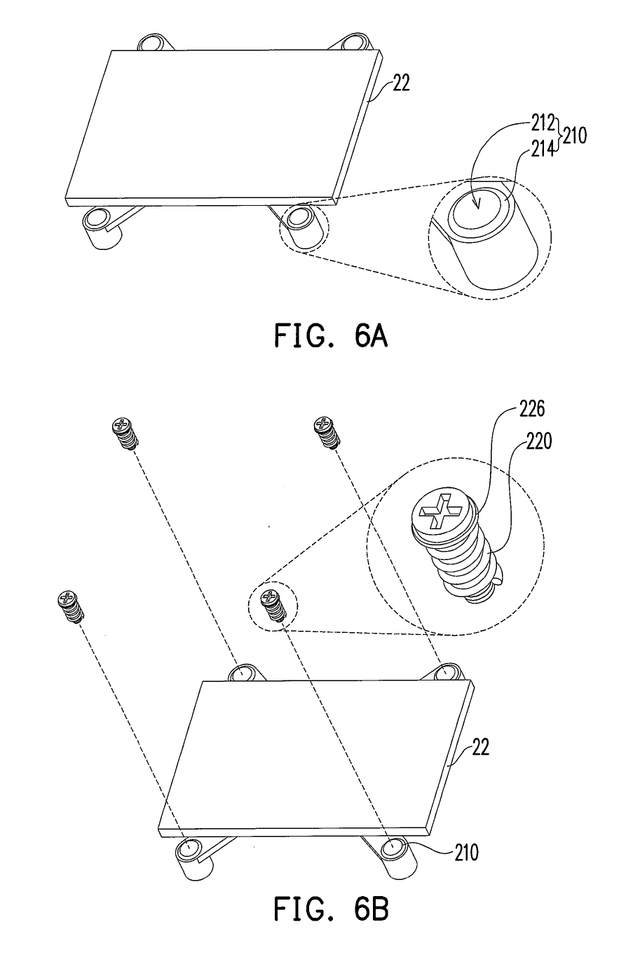

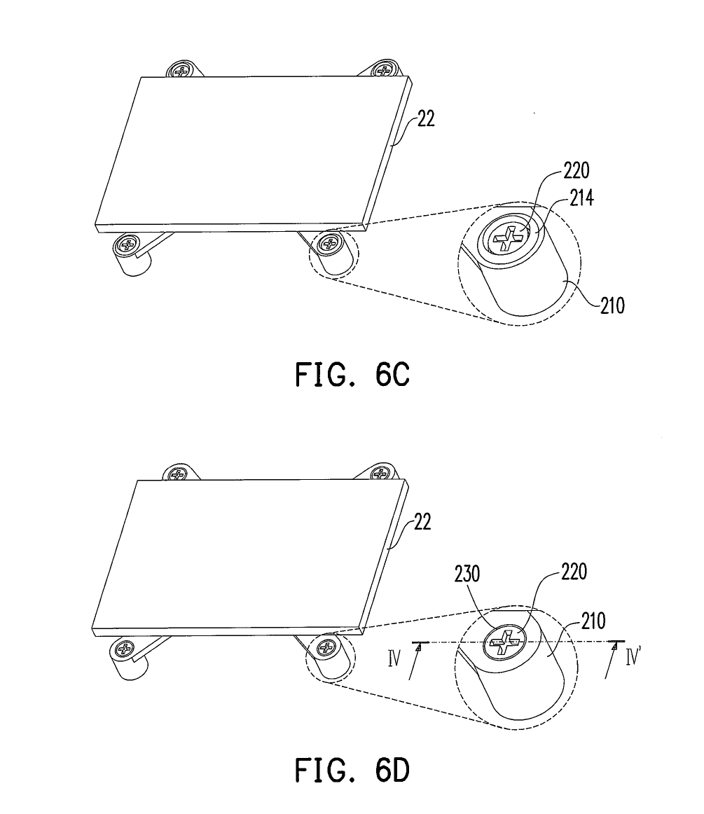

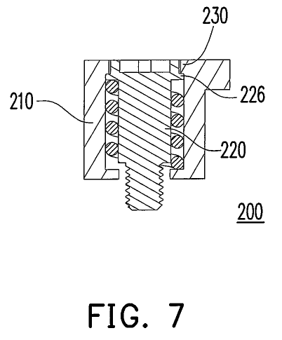

The fixing method shown in FIG. 4A to FIG. 4D is not the only embodiment in the invention, another embodiment of the invention is described hereinbelow, and to make the description convenient, the same reference numbers are used to denote the same elements. Please refer to FIG. 6A to FIG. 6D, which are flowchart schematic diagrams showing another fixing method of a preferred embodiment of the invention. The fixing method of the embodiment is similar with the fixing method of the above embodiment, and the difference between them is that in this embodiment, a fastening structure 226 (as shown in FIG. 6B) is provided at the outer edge of the top of the fixer 220, and the limiting portion 230 which is formed by deforming toward the fixer 220 is provided at the upper edge (as shown in FIG. 6D) of the fastening structure 226. Except for the above difference, this embodiment and the above embodiment is not different from each other. The relative relationship between the fastening structure 226 and the limiting portion 230 is described hereinbelow. To make the relative relationship between the fastening structure 226 and the limiting portion 230 clear, please refer to FIG. 6D and FIG. 7 simultaneously (FIG. 7 is a section diagram showing what is shown in FIG. 6D along IV-IV′). As shown in FIG. 6D and FIG. 7, the limiting portion 230 in the embodiment also can be formed at the upper edge of the fastening structure 226. In this way, the limiting portion 230 also has a function of limiting the fixer 220 in the holding space 212. That is, in the fixing device 200, the limiting portion 230 interferes with the fastening structure 226.

To sum up, in the fixing method of the invention, a protrusion is provided around the holding space of the fixing structure. After the fixer is put into the holding space, since the protrusion has a characteristic of extension, the invention can make the protrusion deformed toward the fixer to form a limiting portion to obtain the objective of fastening the fixer in the holding space. Compared with the conventional technology that the fastening element such as an E-ring is additionally used to limit the position of the fixer, the fixing method and the fixing device of the invention have the following advantages.

First, since the fixer is directly fastened in the holding space in the invention, the invention has a preferred structure assembly efficiency.

Second, since the fastening element such as an E-ring does not need to be used additionally to limit the position of the fixer in the invention, the fixing device of the invention has a low product cost.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A fixing method comprising the steps of:
providing a fixing structure having a holding space and a protrusion provided around the holding space;
placing a fixer into the holding space; and
making the protrusion deformed toward the fixer to form a limiting portion which limits the fixer in the holding space.

2. The fixing method according to claim 1, wherein before the fixer is limited in the holding space, the diameter of an opening at a side of the holding space where the protrusion is provided is larger than the diameter of an opening at another side.

3. The fixing method according to claim 1, wherein after the fixer is limited in the holding space, the diameter of an opening at a side of the holding space where the limiting portion is provided is less than the outer diameter of the top of the fixer.

4. A fixing device comprising:
a fixing structure having a holding space and a limiting portion provided at the inner wall of the holding space; and
a fixer limiting in the holding space by the limiting portion.

5. The fixing device according to claim 4, wherein the holding space has an opening at a side of the holding space where the limiting portion is provided, and the diameter of the opening is less than the outer diameter of the top of the fixer.

6. The fixing device according to claim 4, wherein the outer edge of the top of the fixer has a fastening structure, and the limiting portion interferes with the fastening structure.

7. The fixing device according to claim 6, wherein the holding space has an opening at a side of the holding space where the limiting portion is provided, and the diameter of the opening is less than the outer diameter of the fastening structure.

8. The fixing device according to claim 4, wherein the fixer is a spring screw.
